(19) United States
(12) Patent Application Publication
(10) Pub. No.: US 2004/0019500 A1
(43) Pub. Date: Jan. 29, 2004

(54) System and method for providing corporate governance-related services

(76) Inventor: Michael Ruth, Andover, MA (US)

Correspondence Address: TESTA, HURWITZ & THIBEAULT, LLP, HIGH STREET TOWER, 125 HIGH STREET, BOSTON, MA, 02110, US

(21) Appl. No.: 10/621,081

(22) Filed: Jul. 16, 2003

Related U.S. Application Data
(60) Provisional application No. 60/396,137, filed on Jul. 16, 2002.

(51) Int. Cl. G06F 17/60

(52) U.S. Cl. 705/1

(57) ABSTRACT

The invention relates to a system and method for facilitating compliance with at least one corporate governance standard. The system and method include receiving information from a service provider. The system and method also include facilitating compliance with the corporate governance standard(s) for at least one of an accounting service, a legal service, a banking service, a corporate service, an insurance service, a health, medical, and welfare benefit service, and a government regulatory service.

### CROSS-REFERENCE TO RELATED APPLICATIONS

This application claims priority to U.S. provisional patent application serial No. 60/396,137, filed Jul. 16, 2002 and is incorporated by reference herein.

### FIELD OF THE INVENTION

The invention relates generally to a system and method for providing a multi-professional format/platform as an exchange environment for professional service practices such as law, accounting, training, and compliance, and more particularly to a system for providing corporate governance support using a web-enabled platform.

### BACKGROUND OF THE INVENTION

In the earliest days of free enterprise, there was little distinction to be drawn between ownership and management of business entities. In most cases, these roles were played by the same individuals, who brought to the economic system their own personal goals and aspirations and, in turn, their own sense of accountability. For better or worse, this direct personal involvement provided the essential driving force of our economic growth and development.

As these private enterprises grew and evolved, however, new forms of ownership emerged, beginning with the various forms of partnership and proceeding to the development of the modern corporation. In this form, a gap appeared, and then widened, between the functions and actions of a corporation and its accountability. The need to bridge this gap has in turn provided the foundation for contract law and our country's standards of accounting practice, all formal mechanisms devised to codify and monitor the various relationships between and within business entities.

Typically, the legal and accounting practices are provided by either (or both) an internal legal and accounting staff or one or more outside legal and accounting firms. Although such services help corporations in their daily operations, communications between these groups are often lacking or non-existent. Regrettably, corporate entities may have run afoul of the law, as was recently shown with the Enron Corp., Arthur Andersen LLP, and WorldCom fiascoes.

### SUMMARY OF THE INVENTION

Thus, there remains a need for providing corporations with a technique to properly conduct their businesses using the many outlets available to them while not losing sight of honesty, integrity, and the law.

In one aspect, the invention relates to a corporate governance system, or corporate governance module. The corporate governance module includes a receiving module that receives information from a service provider. The corporate governance module also includes a compliance module in communication with the receiving module to facilitate compliance with one or more corporate governance standard for at least one of an accounting service, a legal service, a banking service, a corporate service, an insurance service, a health, medical, and welfare benefit service, and a government regulatory service. In one embodiment, the government regulatory service is part of the corporate service.

In one embodiment, the service provider includes an external service provider and/or an internal service provider. The service provider can be one or more of the accounting service, a legal service, a banking service, a corporate service, an insurance service, a health, medical, and welfare benefit service, and a government regulatory service. In another embodiment, the corporate governance module includes an account review module that facilitates the securing of insurance coverage. Moreover, the account review module can facilitate completion of an insurance form to obtain the insurance coverage. Further, the account review module can evaluate one or more of an insurance policy, an insurance carrier, an insurance agency, an insurance salesperson, a brokerage firm, a banking policy, a bank, a brokerage carrier, and a brokerage policy. In another embodiment, the compliance module facilitates compliance with a training standard and/or a corporate strategy. The corporate governance module can also include an employee benefits module that facilitates development of an employee benefits program.

In another aspect, the invention relates to a method for facilitating corporate governance. The method includes the steps of receiving information from a service provider and facilitating compliance with one or more corporate governance standard for one or more of an accounting service, a legal service, a banking service, a corporate service, an insurance service, a health, medical, and welfare benefit service, and a government regulatory service.

In one embodiment, the method includes facilitating training to comply with the corporate governance standard and verifying the compliance with the corporate governance standard. The method can also facilitate development of an employee benefits program and the facilitating securing of insurance coverage. Additionally, the method can include the step of enabling a client, such as a service provider, to view information associated with the corporate governance standard and/or a different service provider.

In another aspect, the invention relates to a method for facilitating corporate governance that includes the steps of receiving instructions from a client and facilitating compliance with the instructions. The method also includes the steps of using the instructions to train a user and verifying the compliance of the instructions.

In yet another aspect, the invention relates to a means for receiving information from a service provider and a means for facilitating compliance with the corporate governance standard for at least one of an accounting service, a legal service, a banking service, a corporate service, an insurance service, a health, medical, and welfare benefit service, and/or a government regulatory service.

### BRIEF DESCRIPTION OF THE DRAWINGS

The advantages of this invention may be better understood by referring to the following description in conjunction with the accompanying drawings, in which like numerals indicate like structural elements and features in various figures. The drawings are not necessarily to scale, emphasis instead being placed upon illustrating the principles of the invention.

FIG. 1 illustrates a block diagram of an embodiment of services associated with a corporation communicating with a corporate-governance information platform.

FIG. 2 illustrates a block diagram of an embodiment of a corporate governance support system according to the present invention.

FIG. 3 illustrates a more detailed block diagram of an embodiment of a corporate governance module according to the present invention.

FIG. 4 illustrates a block diagram of an embodiment of a front-end and a back-end of the corporate governance module according to the present invention.

FIG. 5 illustrates a flow diagram of an embodiment of the functions performed by the corporate-governance information platform.

FIG. 6 illustrates an exemplary screen shot depicting an embodiment of functions performed by an account review section of the corporate-governance information platform.

FIG. 7 illustrates an exemplary screen shot depicting an embodiment of functions performed by a compliance section of the corporate-governance information platform.

### DETAILED DESCRIPTION

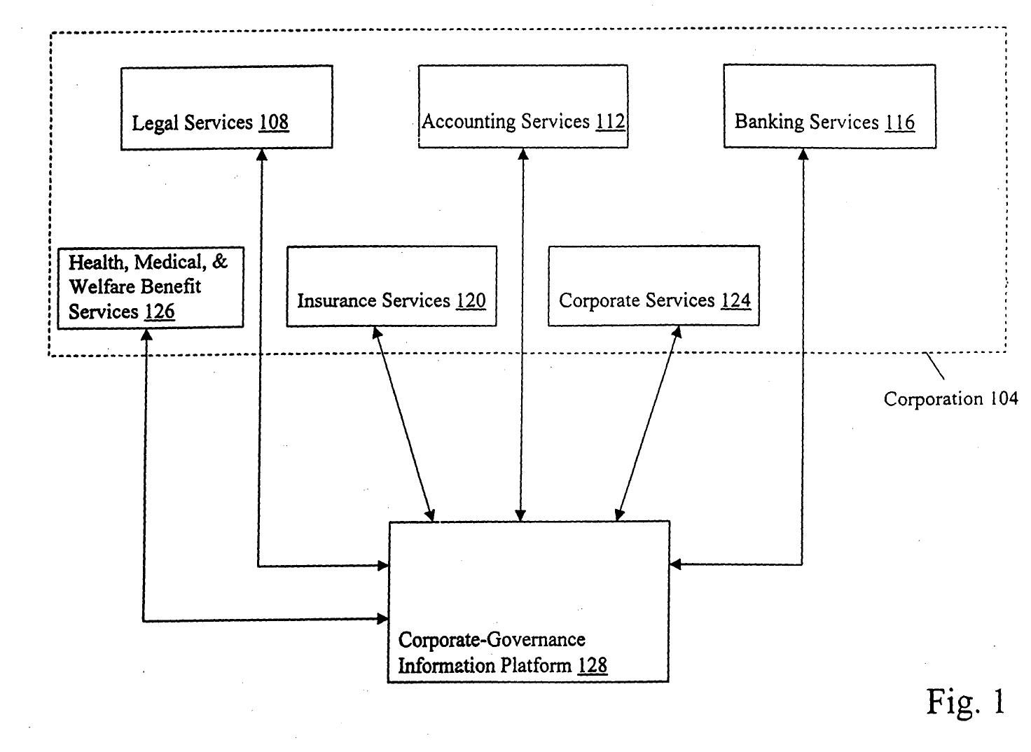

FIG. 1 illustrates an embodiment of a variety of services, branches, and/or types of information that a corporation 104 is typically involved with or conducts business with to successfully achieve its goals. These branches may include, but are not limited to, legal services 108, accounting services 112, banking services 116, insurance services 120, corporate services 124, and/or health, medical, and welfare benefit services 126. A corporate-governance information platform (or information platform) 128 facilitates the communication between these services 108, 112, 116, 120, 124, 126. Although illustrated as communicating with these services 108, 112, 116, 120, 124, 126, however, it should be clear that the information platform 128 may facilitate communications with any number of these services or any other service. Moreover, although illustrated as part of a corporation 104 (i.e., internal service providers), these services may alternatively be outside partners, such as an external law firm or an external accounting firm, or both internal and external service providers.

The legal services portion 108 of the corporation 104 may include one or more attorneys or legal staff (e.g., paralegals) who review and analyze legal matters. Examples of these legal matters include, but are not limited to, contractual issues, torts, fraud, corporate law, antitrust issues, personal injury, intellectual property, labor law, civil procedure, and evidentiary matters. As a corporation 104 ideally endeavors to act in a lawful manner in connection with all transactions and agreements, the legal services group 108 can review any and all matters relating to any of the other services in addition to legal services. For instance, the legal services section 108 can review an insurance form to ensure that the form complies with federal and state law. It is also beneficial to have another sector of the corporation 104 review legal documents to ensure the documents meet corporate objectives. Further, a corporation 104 can benefit by having the legal department review banking documents and accounting documents, such as the accounting books. This can ensure that the corporation 104 is (and has been) reporting the correct gains and losses, taxes, etc., consequently minimizing (e.g., preventing) the unfortunate collapse recently seen with certain companies. Thus, it is often imperative and in a corporation's best interests to have the legal services section 108 of its organization communicate with many of its other sections.

The accounting services 112 include accountants and other accountant personnel, as well as any accounting information (e.g., accounting books) of the corporation 104. As every dollar spent and earned is ideally accounted for, the accounting books have to be accurate and current. Further, corporations 104 cannot conduct business without ensuring that available funds are present for any transactions. Because of these issues, in one embodiment the accounting services group 112 reviews and analyzes all corporate documentation, agreements, transactions, etc. This review and analysis can facilitate the correct and proper accounting practices for the corporation 104.

Similarly, the banking services 116 may include banking personnel and banking documents. Like the accounting services section 112, in one embodiment corporate transactions and agreements comply with the banking practices 116 of the corporation 104. Further, it is usually vital to the corporation's survival to ensure availability of the appropriate cash reserves for a particular action. For instance, if a board member of a corporation 104 presents a proposal to other board members regarding training all employees of the corporation 104, the board member may want to have the banking and/or accounting sections review and analyze the proposal to guarantee that the proposal is feasible considering the amount of cash reserves available for internal employee training. Thus, it is typically in a corporation's best interest to have many services 108, 112, 116, 124, 126 review and analyze agreements, presentations, and/or transactions.

Furthermore, the insurance services 120 include, for instance, insurance personnel, insurance forms, insurance procedures and other insurance-related information. When creating an insurance form, it can be advantageous for a corporation 104 to have its other sectors (e.g., legal services 108) review the form for compliance with the law. Likewise, it is important that the insurance form (e.g., the cap on the insurance policy) meets expected accounting requirements and practices. Further, in one embodiment, insurance practices follow corporate strategies and procedures. Thus, a corporation 104 can benefit from having its other sectors 108, 112, 116, 124, 126 review and/or analyze insurance-related issues and documentation.

The corporate services 124 can include the corporate management (e.g., the board of directors), managerial materials, human resources, staffing matters, information and/or employees associated with employee benefits (e.g., 401K benefits), and the like. The corporate services section 124 typically make the decisions for the corporation 104. With this power also comes the responsibility of ensuring that every agreement, transaction, internal process (e.g., training of employees), and external process complies with the law and that proper insurance exists. Thus, communication between the corporate services 124, the legal services 108, and the insurance services 120 are vital to a corporation 104 maintaining proper business practices.

Further, as described above, the operation of a business entails the accounting of money. Thus, the corporate services 124 often (if not always) have to communicate with banking services 116 and accounting services 112. By communicating with the services described (either continuously or at proper times), a corporation 104 can conduct business in a proper fashion, thereby minimizing deceptive and untrustworthy statements or practices. For instance, when a corporation 104 releases its accounting books to the public, if the legal department 108 has also reviewed and analyzed these books for any legal issues, the public and the business can be more confident in what it is releasing. Business integrity today is more important than ever, often resulting in long-standing relationships with customers.

The health, medical, and welfare benefits service 126 can include services such as human resources, health management, fitness information or personnel, workers' compensation services, state and/or federal law issues. This service 126 can be part of another service or can be internally or externally located from the corporation 104.

As stated above, the corporate-governance information platform (or information platform) 128 facilitates the communication between these services 108, 112, 116, 120, 124, 126. Thus, using the corporate-governance information platform 128, the corporation 104 enables one service, such as the legal service 108, to review and analyze documentation relating to another service, such as an insurance form from the insurance service group 120. As described in more detail below, this hub-and-spoke approach facilitates corporate governance of corporations 104 through training, compliance, and verification.

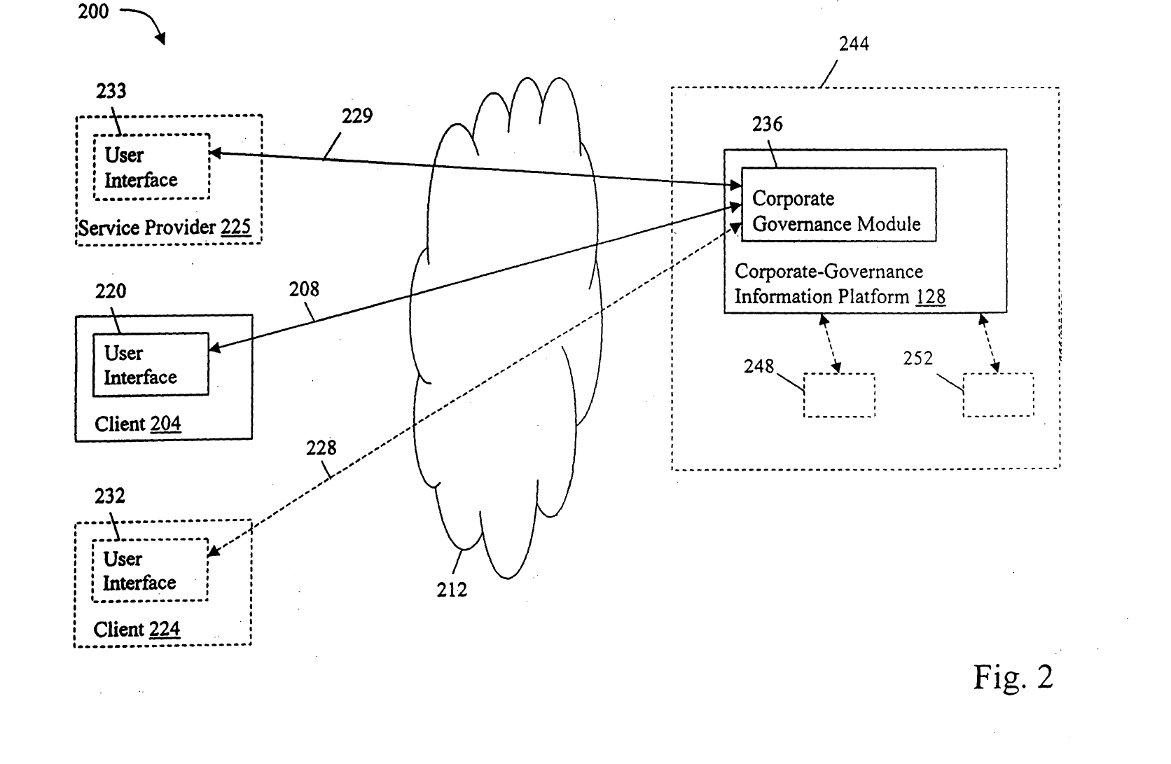

Referring to FIG. 2, a corporate governance support system 200 includes a client computer (or client) 204 and the corporate-governance information platform 128. The client 204 communicates with the information platform 128 over a communications path 208 and a communications network 212. It should be noted that FIG. 1 is an exemplary embodiment intended only to illustrate, and not limit, the subject technology.

In one embodiment, the client 204 can be a computing device (e.g., personal computer such as a 286, 386, 486, Pentium, Pentium II, Macintosh computer), Windows-based terminal, network computer, wireless device, information appliance, RISC Power PC, X-device, workstation, mini computer, main frame computer, personal digital assistant, or other computing device that can connect to a network. Windows-oriented platforms supported by the client 204 can include, without limitation, WINDOWS 3.x, WINDOWS 95, WINDOWS 98, WINDOWS NT 3.51, WINDOWS NT 4.0, WINDOWS 2000, WINDOWS CE, WINDOWS XP, MAC/OS, Java, and UNIX. The client 204 can include a visual display device (e.g., a computer monitor), a data entry device (e.g., a keyboard), persistent or volatile storage (e.g., computer memory) for storing downloaded application programs, a processor, and/or a mouse.

In one embodiment, the client 204 also includes a user interface 220. The interface 220 can be text driven (e.g., DOS) or graphically driven (e.g., Windows). In one embodiment, the client user interface 220 is a web browser, such as INTERNET EXPLORER developed by Microsoft Corporation (Redmond, Wash.), connected to the communications network 212. In a further embodiment, the web browser 220 uses the existing Secure Socket Layer (SSL) support developed by Netscape Corporation (Mountain View, Calif.), to establish the communications network 212 as a secure network.

In yet another embodiment, a second client 224 communicates with the information platform 128 over a second communications path 228. The second client 224 may include the same components as the client 204, such as having a user interface 232. Further, the second communications path 228 may be equivalent to the first communications path 208. Alternatively, the second communications 228 may have different characteristics (e.g., different transmission data rate) than the first communications path 208. In another embodiment, the second communications path 228 passes through a different network than the communication network 212. Additionally, although the corporate governance support system 200 is illustrated in FIG. 2 with two clients 204, 224 and described below in terms of the client 204, the corporate governance support system 200 supports any number of clients.

In one embodiment, an external service provider 225 is a client of the corporate-governance information platform 128. The external service provider 225 may provide one or more of the services described in FIG. 1. Similar to the previously described clients 204, 224, communicates over a third communications path 229, which has the same characteristics (e.g., different or same transmission data rate as first (or second) communications path 208, 228) of the previously described communications paths 208, 228. Moreover, similar to the previously described clients, the external service provider 225 can have a user interface 233 (e.g., an Internet browser). Although described below with reference to the first client 204, the description applies to any of the clients 204, 224, 225.

The communications network 212 can be a local-area network (LAN), a medium-area network (MAN), or a wide area network (WAN) such as the Internet or the World Wide Web (i.e., web). In one embodiment, the communications network 212 is a satellite (e.g., 3G standard). In one embodiment, the communications network 212 (i.e., the communications path 208) supports secure communications. In a further embodiment, communications occur after the information platform 128 verifies a client user's password. Exemplary embodiments of the communications path 208 include standard telephone lines, LAN or WAN links (e.g., T1, T3, 56 kb, X.25), broadband connections (ISDN, Frame Relay, ATM), and wireless connections. In one embodiment, the communications path 208 enables phone or other mobile-based units of contact, storage, communication verification or documentation. The connections over the communications path 208 can be established using a variety of communication protocols (e.g., TCP/IP, IPX, SPX, NetBIOS, Ethernet, RS232, and direct asynchronous connections).

An operator of the client 204 may be a member of one or more of the services 108, 112, 116, 120, 124, 126 described in FIG. 1 (e.g., an attorney, an accountant, a human resource department personnel in charge of setting up a program such as an employee benefits program). The operator of the client 204 may also be, for example, an individual, personnel from an insurance company, or an employee of another corporation (e.g., a customer of a first corporation).

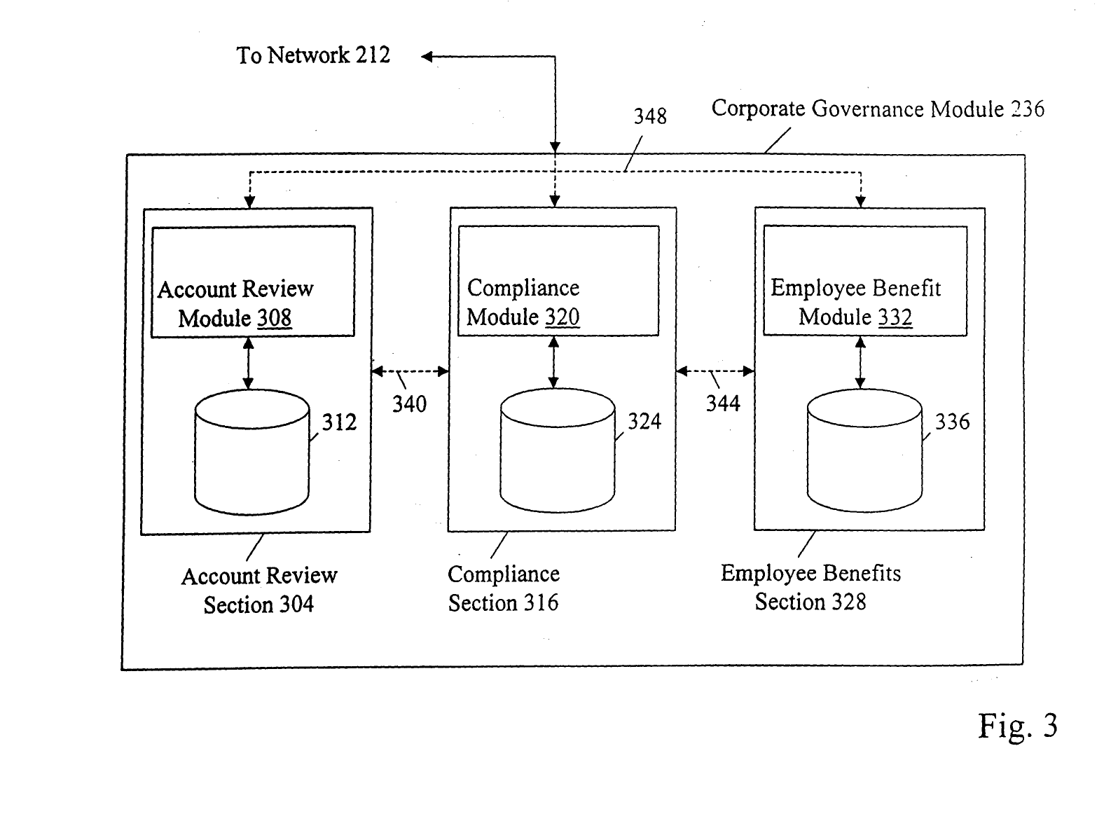

The information platform 128 can be any computing device described above. As described in more detail below with respect to FIG. 3, the information platform 128 additionally hosts a corporate governance module 236 to perform functions based on, for instance, data received from the client 204. Additionally, although illustrated in FIG. 1 as modules within the information platform 128, the corporate governance module 236 may instead be externally located from and in communication with the information platform 128.

In one embodiment, the corporate governance module 236 includes a memory module for storing a corporate governance standard. The memory module can be any memory device, such as a database, memory (e.g., Random Access Memory, Read-Only Memory), a hard drive, a disk, a writeable CD-ROM, etc.

In another embodiment, the information platform 128 is a member of a server farm 244, which is a logical group of one or more servers that are administered as a single entity. In the embodiment shown, the server farm 244 includes the information platform 128, a second information platform 248, and a third information platform 252. Moreover, the corporate-governance information platform 128 can be implemented with one or more fault-tolerant servers with redundant components to minimize server failures.

In one embodiment, the information platform 128 is supported by an application service provider (ASP). The ASP can, for example, provide the information platform 128 to customers and provide a guarantee to these customers that, for instance, the information platform 128 performs in a particular fashion, provides certain functions, etc.

Many advantages are provided by the corporate-governance information platform 128. For instance, the corporate-governance information platform 128 can help owners and board members understand and communicate the impact of the corporation's behavior (e.g., externalizing costs) on corporate competitiveness. Further, the information platform 128 can facilitate the restoration of accountability in a corporation 104 so that the corporation 104 can, for instance, adapt to environmental changes in a more advantageous manner while not neglecting its future existence or reputation. The corporate-governance information platform 128 can do this, for example, through the introduction and emphasis of compliance, verification, and training.

For example, if the chief executive officer (CEO) of a corporation 104 puts forth instructions that every employee has to be trained in safety techniques, the corporation 104 may implement a plan to train each employee. In one embodiment, this plan includes the verification that each employee took part in the training program after the employee finishes their training. Further, the CEO wants to guarantee that this training process has occurred and continues to occur without fail so that the CEO may, for instance, publicize the fact that the corporation 104 is taking part in such training programs without later being embarrassed when someone (e.g., a newspaper reporter) finds otherwise. This embarrassment can lead to losing customers or potential customers as well as a reduction in the corporation's stock price. Thus, the information platform 128 enables corporate governance through this regime of training, verification, and compliance so that such embarrassment and the results that follow do not occur.

Referring to FIG. 3, in one embodiment the corporate governance module 236 has an account review section 304. The account review section 304 is an information repository for critical data related to corporate governance and practices. In one embodiment, the account review section 304 includes an account review module 308. The account review module 308 can be used, for example, to secure insurance coverage for a user of the client 204. Particular examples of insurance coverage analyzed and secured by the account review module 308 include, but are not limited to, insurance coverage for corporate directors and officers (D&O), employment practices liability insurance, and fiduciary liability insurance. The account review module 308 can facilitate and/or analyze the completion of an insurance form to obtain such coverage. Moreover, the account review module 308 may provide instructions on how to complete one or more questions on a form, such as sections in an insurance form that people frequently find difficult. The account review module 308 can alternatively provide services relating to any other type of account, such as services used by an attorney when retaining a new client. For example, the account review module 308 can facilitate the completion of a new client form for a law firm.

In one embodiment, the account review section 304 also includes an account review storage device 312. The account review storage device 312 stores information used by the account review module 308. Thus, the account review storage device 312 can transmit information to and receive information from the account review module 308. Examples of the account review storage device 312 include, but are not limited to, a database, memory (e.g., Random Access Memory, Read-Only Memory), a hard drive, a disk, and a writeable CD-ROM.

In one embodiment, the corporate governance module 236 also includes a compliance section 316. The compliance section 316 includes a compliance module 320 to enable a user of the client 204 to access corporate governance standards and/or links to other sites. In some embodiments, the compliance module 320 is a law firm helping a corporation comply with corporate governance standards. The compliance module 320 can also provide risk management and corporate governance practices to protect a corporation 104. For example, the compliance module 320 may communicate with the communications network 212 to obtain the most current news relating to corporate governance, such as a new law relating to corporations 104 (e.g., corporate fraud). If this law has changed and a corporation 104 does not determine that a new law has been passed relating to the corporation 104, the corporation 104 may not comply with the new law, thereby exposing itself to punishment (e.g., hefty fines). Thus, in one embodiment, the corporation 104 does not expose itself to such punishment if the information platform 128 notifies the corporation 104 via the compliance module 320. Moreover, in one embodiment, the compliance section 316/module 320 performs verification of training (e.g., of employees or of board of directors) to training standards. This verification can avoid a claim for or payment of punitive damages (e.g., for not following these training standards).

The compliance module 320 further ensures that the corporation is conforming to the corporate strategy, such as instructions given by the CEO. This may be accomplished via random checks of employees, postings of announcements, etc.

Similar to the account review section 304, in one embodiment the compliance section 316 includes a compliance storage device 324. The compliance storage device 324 stores information used by the compliance module 320. Thus, the compliance storage device 324 can transmit information to and receive information from the compliance module 320. The examples described above for the account review storage device 312 also apply to the compliance storage device 324.

The corporate governance module 236 additionally includes an employee benefits section 328. In one embodiment, the employee benefits section 328 includes an employee benefits module 332 to facilitate the development (or monitoring/updating) of an employee benefits program. In further embodiments, the employee benefits module 332 contains information about a census form. The employee benefits module 332 may also be able to create or enter information into the census form. The census form can be used for providing information on a corporation's employees (to develop the employee benefits program). In one embodiment, the census form contains basic employee data, such as an employee's name, date of birth, social security number, sex, and/or marital status. The form may also ask for additional information, such as income level of an employee, health concerns, weight, height, and driver's license number.

The employee benefits module 332 may also provide historical data on an insurance plan and its pricing, details on the structure of an insurance plan, insurance options available to employees, information, such as history, relating to insurance claims, and claim forms for employees. In some embodiments, the employee benefits section 328 (and/or other sections 304, 316, 328) enable the client 204 to access one or more partners of the information platform 128. For instance, the information platform 128 may have a partner that provides assistance in determining suitable practices of employer management of employees. In one embodiment, the user of the client 204 uses the employee benefits module 332 to access the information of the partner.

In one embodiment, the employee benefits module 332 also utilizes high deductibles and/or self-insurance with traditional or non-traditional cost incentive-based plans. The module 332 can also suggest or even mandate the review or interaction of multi-professionals, particularly reviewing cash flow, proper allocation of liabilities carried forward, and creative financial instruments and practices utilizing traditional letters of credit (LOC), bonds, or creative variations of the same.

In one embodiment, the employee benefits section 328 includes an employee benefits storage device 336. The employee benefits storage device 336 performs similar functions as the other storage devices but with respect to the employee benefits module 332. Likewise, the examples described above for the other storage devices also apply to the employee benefits storage device 336. Moreover, although illustrated as three independent storage devices 312, 324, 336, the information platform 128 may have any number of storage devices communicating with one or more of the account review section 304, compliance section 316, and employee benefits section 328. Moreover, the storage devices 312, 324, 336 can be internal or external to any of the sections 304, 316, 328 or the information platform 128.

Likewise, any function described above performed by one of the account review section 304, compliance section 316, and employee benefits section 328 may alternatively be performed by any of the other sections 304, 316, 328. Moreover, any section 304, 316, 328 may communicate with (transmit information to and receive information from) any other section 304, 316, 328 via one or more section communication links 340, 344. Likewise, in one embodiment, any of the sections 304, 316, 328 may communicate with the communications network 212 via a section communications link 348.

Further, the modules 308, 320, 332 and/or sections 304, 316, 328 may be, for example, an entire computer application program or a large or small portion of a computer application program (e.g. a subroutine or a subsystem, one or more objects, tasks, etc.). The modules 308, 320, 332 and/or sections 304, 316, 328 may also be written in a specific programming language (e.g. C++, Java, C#, Fortran, perl, etc.), or may be coded in one of a choice of programming languages or coding formats.

In one embodiment, any or all of the sections 304, 316, 328 and/or modules 308, 320, 332 can communicate with outside service providers, such as external law firms. Thus, the sections 304, 316, 328 and/or modules 308, 320, 332 can communicate with external service providers, internal service providers, or both external and internal service providers.

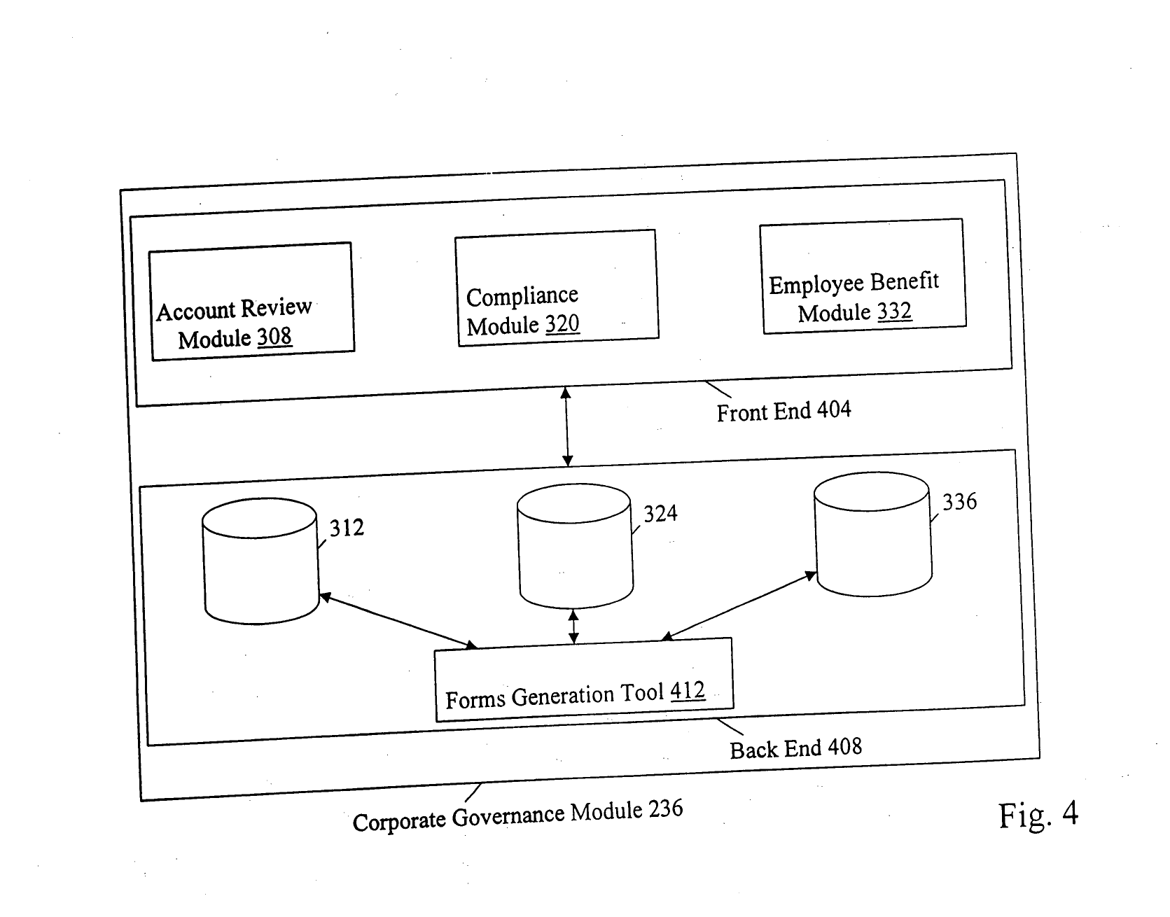

Referring to FIG. 4, in one embodiment the corporate-governance information platform 128 is divided into a front-end 404 and a back-end 408. In one embodiment, the front-end 404 includes the modules 308, 320, 332 described above and generates/updates the web page that one or more users can access.

The back-end 408 enables the storing of data, such as for comparing and analyzing, and may include the storage devices 312, 324, 336. In some embodiments, the storage and analysis features can serve as proof of compliance to, for instance, a corporate governance standard, legal documentation and/or accounting practices.

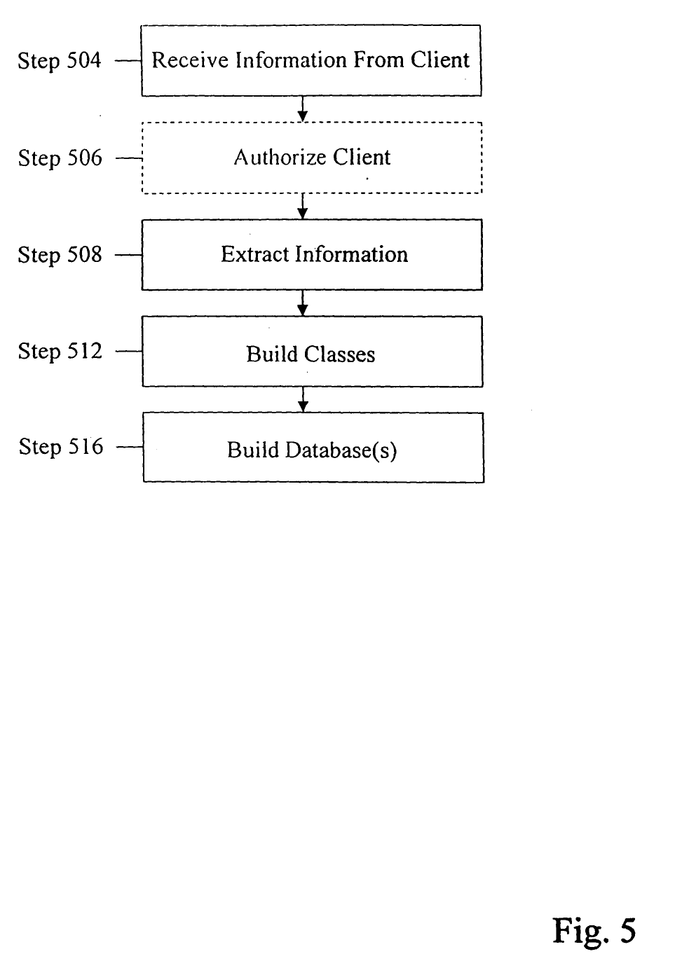

This subsequent analysis of data may be used, for example, to study the trends of the results of actions performed by a corporation 104 for future modification of behavior. The front-end 404 provides the interface to the data stored in the back-end 408. Also referring to FIG. 5, in one embodiment the front-end 404 receives input from a client 204 (e.g., the client user entering information into a web page) (STEP 504). In one embodiment, the information includes login information, such as a user name and password. If this is the case, the information platform 128 authorizes the client 204 (STEP 506) by verifying the user name and/or password. The back-end 408 extracts the client user's information from the web page (STEP 508) for subsequent analysis. Alternatively, the front-end 404 transmits the information to the back-end 408 for the additional processing.

In one embodiment, the back-end 408 also includes a forms generation tool 412. In one embodiment, the forms generation tool 412 is a software module that generates standard forms for a particular service, such as standard insurance forms for the insurance service 120. In one embodiment, these insurance forms follow the corporate governance standards. In one embodiment, the forms generation tool 412 extracts the information from the front-end 404, as described above, and uses the information to build database classes (STEP 512) relating to, for instance, standard insurance forms. Examples of these classes include, but are not limited to, accounts, prior carrier, loss history, general liability, workers compensation, and locations. These classes are high-level classifications to organize the forms and information associated with the forms in the storage devices 312, 324, 336. In one embodiment, the class groups objects having the same properties. Thus, for each class, different forms (e.g., insurance forms) may exist. For instance, different insurance forms may exist for different locations of a corporation 104 (or individual) and/or for different accounts.

In one embodiment, the forms generation tool 412 then uses these classes to automatically build a database (STEP 516). In further embodiments, the forms generation tool 412 builds a relational database and class relationships for the database automatically. In some embodiments, the forms generation tool 412 can handle any number of class relationships to develop the database. Once the class is created, the back-end 408 then puts all data received after the class creations into a particular class. Thus, the data can get a class indicator denoting which class the data belongs. The back-end 408 performs these functions so that relationships exist between data, enabling, for example, one entry in the database to be associated with many different other entries. Further, the back-end 408 automatically maps each form to a class. This automatic mapping reduces the time needed to introduce a new insurance form or other information (e.g., document) into the information platform 128 (e.g., into a web page). Thus, the information platform 128 can provide an entry-level individual with the ability to create and send information associated with an insurance form, for instance, after the back-end 408 has built an account to which this form is associated. Further, the information platform 128 facilitates a collaborative work environment in which the various branches of a corporation (or various corporations) can communicate and/or access other service's documents, etc.

Moreover, the front-end 404 and/or the back-end 408 may change the graphics surrounding the interface to enter information (i.e., the interface provided by the front-end 404). For example, the front-end 404 may display different graphics in a web page depending on which client 204 is accessing the information platform 128. Moreover, the front-end 404 may display the different graphics in response to the back-end 408 transmitting a command to the front-end 404 after processing the extracted information and determining which client 204 is accessing the information platform 128.

The information platform 128 can also enable an information platform administrator (and/or client user) to search for particular forms. As described above, the information platform 128 can enable a collaborative work environment by enabling the transfer of, review of, and editing of information by multiple people in the same service sector or same corporation. For example, a first employee of a corporation 104 operating at a first client 204 may want to send a second employee of the corporation 104 operating at a remotely-located second client 224 a particular corporate governance document for review. The first employee can request (via the first client 204) this transmission to the second client 224 and the information platform 128 performs this transmission. In further embodiments, the information platform 128 also determines, before sending the corporate governance document, whether the information platform 128 has previously transmitted this document to the second client 224. If so, the information platform 128 may not perform the transfer or may transmit a message stating the document has previously been transmitted. The information platform 128 may still accept an additional request from the second client 128, however, to re-transmit this same document. In such a case, the information platform 128 transmits the same document to the second client 224. In other embodiments, the information platform 128 automatically transmits the document to the second client 224 upon receipt of a request.

Moreover, the back-end 408 may only enable particular forms or documents to be viewed by particular clients 204. Thus, in one embodiment the back-end 408 configures each piece of information to be accessed by particular clients 128 or client users. In one embodiment, the back-end 408 determines which forms a user can view based on the login password of the user. In another embodiment, the back-end 408 enables access to certain information in an insurance form, such as by enabling a user to access only several entries in a large insurance form. For example, if an employee of a corporation 104 is accessing a liability insurance form of the corporation 104 (which was initially completed by a board member of the corporation 104), the back-end 408 may not enable the employee to view, for example, the amount of coverage obtained by the corporation 104. In one embodiment, this information is only accessible upon entry of a particular password (e.g., the board member's password).

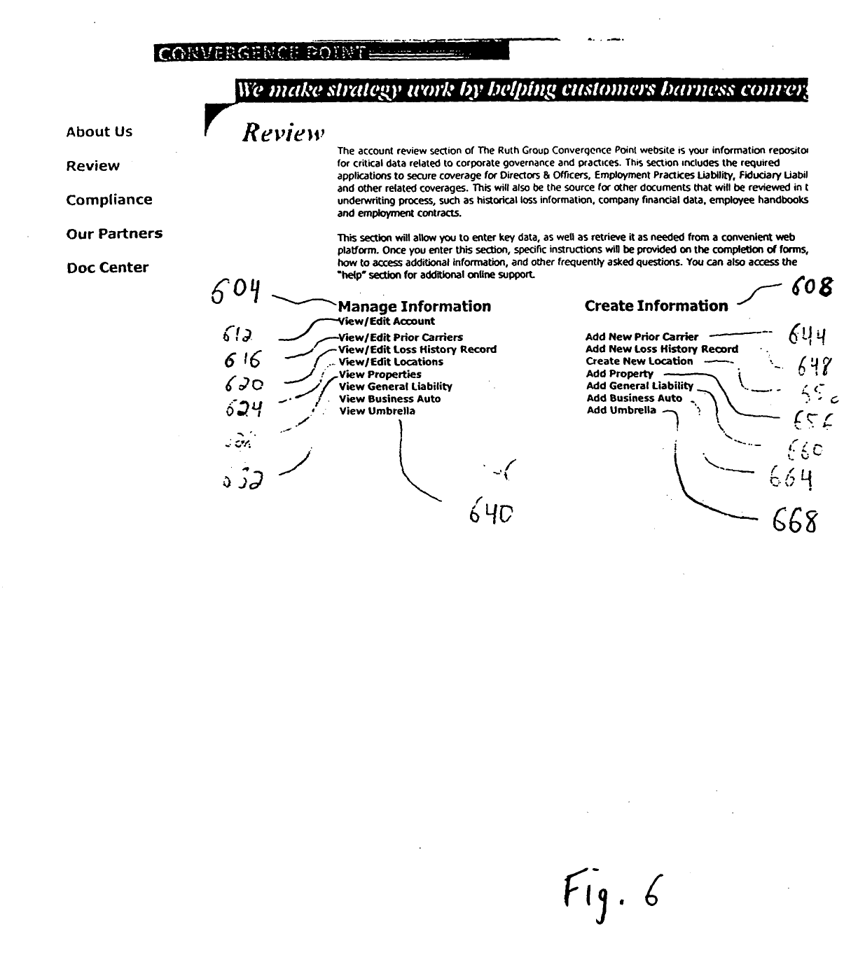

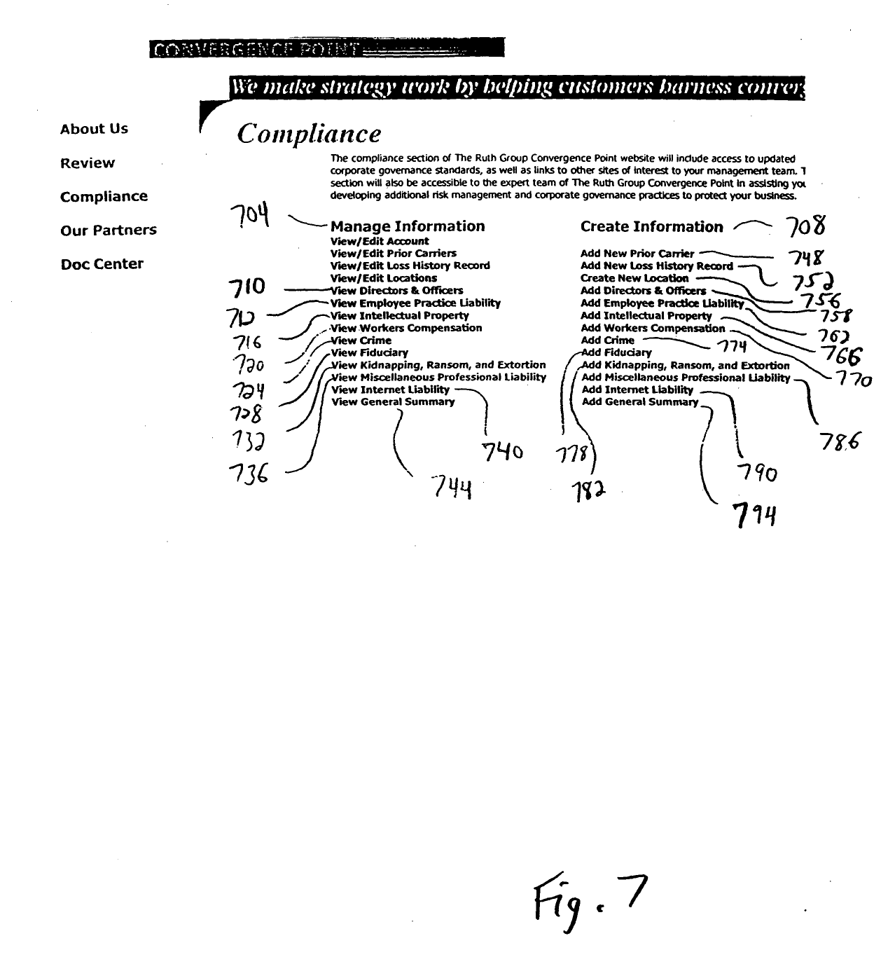

It should be clear that FIG. 4 and FIG. 5 are each one embodiment of the corporate governance module 236 and the steps performed by the module 236. These examples are not intended to limit the scope of the corporate governance module 236 and the functions and/or steps that it performs. Furthermore, the exemplary screen shots described below in FIG. 6 and FIG. 7 are embodiments of screen shots used by the information platform 128. These screen shots are not intended to limit the information platform 128 and should instead be used as one example.

Referring to FIG. 6, an exemplary screen shot of functions made available by the account review section 304 are shown. The functions are divided into two separate categories—the creation of information 604 and the management of information 608. In the management of information section 608, the functions available include the viewing/editing of the account 612, the viewing/editing of prior carriers 616, the viewing/editing of the loss history record 620, and the viewing/editing of locations 624.

The viewing/edition of prior carriers 616 may include, for instance, editing of information regarding the previous insurance policy number, the name of the previous carrier, the policy type (e.g., claims made and occurrence), the expiration date of the previous policy, the limits of the policy, such as the general aggregate, personal injury limit, fire damage limit, medical expense limit, bodily injury occurrence limit, and the like. The form used to organize the prior carrier information is presented in a simple, clear, and organized fashion. Moreover, in one embodiment the form fills at most one to two pages for fast and easy submission and retrieval of information. The account review section 304 may further generate these standardized forms via the forms generation tool 412. Similarly, the viewing/editing of a location 624 may include, for example, having different insurance plans for different addresses.

In the management of information section 608, the functions available can also include the viewing of insurance relating to multiple properties 628, viewing of a general liability plan 632, viewing of business auto insurance 636, and/or viewing of an umbrella insurance policy 640. Moreover, similar exemplary functions are available with respect to the creation of information 608, as shown with functions 644-668.

Referring to FIG. 7, the compliance module 320 makes available similar types of functions relating to corporate governance standards. These are also split into a management of information section 704 and a creation of information section 708. These exemplary functions include, but are not limited to, the ability to view/edit standards relating to directors and officers 710, view standards relating to employee practice liability 712, view standards relating to intellectual property 716, view standards relating to workers' compensation 720, view standards relating to crime 724, view standards relating to a fiduciary 728, view standards relating to kidnapping, ransom, and extortion 732, view standards relating to miscellaneous professional liability 736, view internet liability standards 740, and/or view a general summary of the corporate governance standards 744. As providing and communicating information is typically essential to running a successful corporation, the compliance section 316 facilitates this information access to help achieve this universal corporate goal.

The compliance section 316 also enables the creation or addition of information associated with the functions described above with respect to the management of information section 704. Exemplary functions 748-794 made available for the creation of information 708 are also illustrated in FIG. 7.

An example of a scenario in which the information platform 128 can help improve a corporation is by providing ways to minimize control risk. In one embodiment, control risk is the risk that a material misstatement in unaudited information is not detected and corrected by a corporation's internal control procedures on a timely basis. As with other risks, this risk may be evaluated at various levels of aggregation (e.g., financial statement level, account balance level) and at various stages during the course of an audit (e.g., client acceptance/retention stage, audit planning stage, etc.). The information platform 128 can help manage this risk through the enabling of communications between a variety of professionals, such as by a corporate governance standard in which employees from the legal branch 108, insurance branch 120, corporate branch 124, and/or banking branch 116 review the information in the accounting branch 112 to minimize such a risk. In some embodiments, one or more of these branches 108, 112, 116, 120, 124, 126 can edit the accounting document made available on the platform 128.

Moreover, in one embodiment the corporate governance module 236 facilitates compliance with Sarbanes-Oxley law. The corporate governance module 236 can provide one or more corporate governance standards that comply with Sarbanes-Oxley to a board of directors of a corporation. For example, the corporate governance module 236 can provide a corporate governance standard that includes instructions to attend board meetings, study the agenda and accompanying board materials in advance, contribute in the board meetings, listen, requiring particular people on the board of directors, such as a financial expert, and be in a position to make an informed decision.

Further, the compliance module 320 of the corporate governance module 236 can include an oversight component. In one embodiment, the oversight component includes a marketplace component. The marketplace component provides a marketplace standard (e.g., for stocks, for publication). The oversight component can additionally include a government oversight component (i.e., government regulatory service) that regulates government actions and/or employees with the law. In one embodiment, the government regulatory service is a part of the corporate services 124. The government oversight component can review actions (e.g., employee actions) of a client 204 in light of current laws. Moreover, the government oversight component can protect retirement funds (e.g., pensions) of employees of a client 204 (e.g., a corporation, investors, and the like). Additionally, the government oversight component can enable a government agency, industry regulatory agency, and/or trade or trade group regulatory agency, such as the Securities Exchange Commission (SEC), the Federal Bureau of Investigations (FBI), the Department of Justice (DOJ), and/or the New York Stock Exchange (NYSE) to review whether a client 204 is actually complying with one or more corporate governance standards.

In one embodiment, the corporate governance module 236 enables its clients 204 to determine whether other clients 204 are using the corporate governance module 236. Further, the corporate governance module 236 may have an option to enable this accessibility. For example, a corporation 204 can set this option to enable another client 204 (e.g., an individual) to view information associated with the corporations 204, such as financial information, the corporate standard that is being followed, the dates/times of board meetings, and the like. This may become useful when, for instance, a user wants to determine whether to invest in a particular corporation 204. The user can determine whether the corporation 204 has enabled this feature and, if so, information associated with the corporation 204. This information can help determine whether the user decides to invest in the corporation 204. Moreover, if a corporation 204 does not set this option, the user may draw a negative inference from the corporation's decision not to provide accessibility to the corporation 204 and, consequently, not invest.

Moreover, the corporate governance module 236 can also provide one or more clients 204 access to corporate governance documents, such as one or more documents describing one or more corporate governance standards. Thus, the corporate governance module 236 is a centralized module of corporate governance information (e.g., associated with corporate governance standards and/or one or more clients 204).

Additionally, the corporate governance module 132 can provide numerous benefits to banking services 116. For instance, the corporate governance module 132 can perform due diligence on new corporate credit clients. This can help, for instance, ensure the highest level of integrity in financial reporting and/or can ensure compliance with new SEC rules for corporate governance.

The corporate governance module 132 can also providing on-going monitoring of clients 204 (e.g., real-time monitoring). In one embodiment, the corporate governance module 236 can check for material adverse change and can ensure compliance with new SEC rules for corporate governance and/or ensure uniform calculation methodology for convenient compliance tests. Moreover, in other embodiments the corporate governance module 132 can provide due diligence on target banks in merger and acquisition activities. The corporate governance module 132 can also assist banks with compliance with laws/regulations, verify continued compliance, train employees, etc.

Similar to Powerpoint developed by Microsoft Corporation (Redmond, WA), the corporate governance module 236 can become a standard for clients 204 to ensure that the clients 204 remain in compliance with current laws and regulations. Thus, the corporate governance module 236 is therefore an assessment tool that can assess the fitness and dynamics of a client 204. Thus, in one embodiment the corporate governance module 236 consequently provides the client 204 and/or local, state, and federal authorities the ability to review and/or analyze the client 204 (e.g., its actions, its finances, etc.). The review and/or analysis can facilitate the determination of whether the corporation is in compliance with current corporate governance standards.

In one embodiment, the corporate governance module 236 facilitates recruitment and retention of quality competent board members of a client. Moreover, the module 236 can be used to provide a certification system enabling clients to confer degrees of accounting, management, and/or finance. Thus, the module 236 can act as a university professor that enables the conferring of these degrees to augment the client's internal corporate governance program. The module 236 can additionally enable strong validation of their certification for the marketplace. Thus, the module 236 can be used in the education and teaching context.

Having described certain embodiments of the invention, it will now become apparent to one of skill in the art that other embodiments incorporating the concepts of the invention may be used. Therefore, the invention should not be limited to certain embodiments, but rather should be limited only by the spirit and scope of the following claims.

What is claimed is:

1. A corporate governance system comprising:
(a) a receiving module that receives information from a service provider; and
(b) a memory module for storing at least one corporate governance standard; and
(c) a compliance module in communication with the receiving module to facilitate compliance with the at least one corporate governance standard for at least one of an accounting'service, a legal service, a banking service, a corporate service, an insurance service, a health, medical, and welfare benefit service, and a government regulatory service.

2. The corporate governance system of claim 1 wherein the service provider further comprises at least one of an external service provider and an internal service provider.

3. The corporate governance system of claim 1 wherein the service provider further comprises at least one of an accounting service, a legal service, a banking service, a corporate service, an insurance service, a health, medical, and welfare benefit service, and a government regulatory service.

4. The corporate governance system of claim 1 further comprising an account review module facilitating securing of insurance coverage.

5. The corporate governance system of claim 4 wherein the account review module facilitates completion of an insurance form to obtain the insurance coverage.

6. The corporate governance system of claim 4 wherein the insurance coverage further comprises at least one of corporate directors and officers insurance, employment practices liability insurance, and fiduciary liability insurance.

7. The corporate governance system of claim 4 wherein the account review module evaluates at least one of an insurance policy, an insurance carrier, an insurance agency, an insurance salesperson, a brokerage firm, a banking policy, a bank, a brokerage carrier, and a brokerage policy.

8. The corporate governance system of claim 1 wherein the compliance module facilitates compliance with at least one of a training standard and a corporate strategy.

9. The corporate governance system of claim 1 further comprising an employee benefits module facilitating development of an employee benefits program.

10. The corporate governance system of claim 1 further comprising at least one of an oversight component, a marketplace component, and a government oversight component.

11. The corporate governance system of claim 1 wherein the at least one corporate governance standard further comprises a plurality of corporate governance standards.

12. A computerized method for facilitating corporate governance comprising:
(a) receiving information from a service provider; and
(b) facilitating compliance with at least one corporate governance standard for at least one of an accounting service, a legal service, a banking service, a corporate service, an insurance service, a health, medical, and welfare benefit service, and a government regulatory service.

13. The computerized method of claim 12 further comprising facilitating training to comply with the at least one corporate governance standard.

14. The computerized method of claim 12 further comprising verifying the compliance with the at least one corporate governance standard.

15. The computerized method of claim 12 wherein the receiving step further comprises receiving information from at least one of an accounting service, a legal service, a banking service, a corporate service, an insurance service, and a health, medical, and welfare benefit service.

16. The computerized method of claim 12 further comprising facilitating securing of insurance coverage.

17. The computerized method of claim 16 further comprising evaluating at least one of an insurance policy, an insurance carrier, an insurance agency, an insurance salesperson, a brokerage firm, a banking policy, a bank, a brokerage carrier, and a brokerage policy.

18. The computerized method of claim 12 further comprising facilitating development of an employee benefits program in compliance with the at least one corporate governance standard.

19. The computerized method of claim 12 further comprising enabling a client to view information associated with at least one of the at least one corporate governance standard and the service provider.

20. The computerized method of claim 12 wherein the facilitating compliance with the at least one corporate governance standard further comprises facilitating compliance with a plurality of corporate governance standards.

21. A computerized method for facilitating corporate governance comprising:
(a) receiving instructions about at least one corporate governance standard from a client;
(b) using the instructions to train a user;
(c) facilitating compliance with the instructions; and
(d) verifying the compliance of the instructions.

22. A corporate governance system comprising:
(a) means for receiving information from a service provider;
(b) means for storing at least one corporate governance standard;
(c) means for facilitating compliance with the at least one corporate governance standard for at least one of an accounting service, a legal service, a banking service, a corporate service, an insurance service, and a health, medical, and welfare benefit service.
